(19) United States
(12) Patent Application Publication
(10) Pub. No.: US 2015/0314256 A1
(43) Pub. Date: Nov. 5, 2015

(54) COVER ASSEMBLY FOR DISPENSING LIQUIDS FROM CONTAINERS

(71) Applicant: 3M INNOVATIVE PROPERTIES COMPANY, Saint Paul, MN (US)

(72) Inventors: Brian S. Boothman, San Jose, CA (US); Stephen C.P. Joseph, Woodbury, MN (US)

(21) Appl. No.: 14/651,429

(22) PCT Filed: Dec. 12, 2013
(86) PCT No.: PCT/US13/74543

§ 371 Date: Jun. 11, 2015

Related U.S. Application Data
(60) Provisional application No. 61/736,688, filed on Dec. 13, 2012.

(51) Int. Cl. B01F 15/02; B01F 3/12; B01F 7/16

(52) U.S. Cl. CPC B01F 15/0292; B01F 7/16; B01F 3/1221; B01F 2215/005

(57) ABSTRACT

Provided are cover assemblies (102) for use with a paint or toner container (106) located on a mixing rack. Using these cover assemblies facilitates moving liquid from the container without reliance on gravity. The cover assemblies comprise: a lid (112) having an upper surface (114) and a lower surface (116); an agitation drive shaft (105) mounted through an aperture in the lid having at least one stirrer (118) affixed thereto; and a fluid conduit (120) having an inlet (132) and being in fluid communication with a discharge opening (107). Fluid can be pumped through a fluid path or can be moved pneumatically.

### TECHNICAL FIELD

This disclosure relates to cover assemblies for dispensing liquids from containers such as paint or toner cans. Dispensing can be done, for example, pneumatically or by pumping from the cans. Specifically provided are cover assemblies for use on containers or cans that also utilize agitation, such as paint cans used for solvent-based toners.

### BACKGROUND

Several automotive paint manufacturers produce paints that require agitation. These paints are typically supplied in cans and employ an agitation device that is integrated into the dispensing lid. Conventional dispensing apparatuses typically rely on gravity feed to move the paint or other liquid from the can. Conventional spouts require periodic cleaning to ensure dried material does not interfere with sealing or with accuracy of dispensed amounts.

There is a need to dispense paints in containers on mixing racks without reliance on gravity. There is also a need to provide dispensing lids for paints that accommodate agitation devices that also provide the ability to deliver the paints accurately while minimizing formation of dried chips or unwanted debris.

### SUMMARY

Provided are cover assemblies and methods of dispensing paints or toners from containers that utilize agitation. These assemblies facilitate dispensing without reliance on gravity.

A first aspect provides a cover assembly for use with a paint or toner container located on a mixing rack, the cover assembly comprising: a lid having an upper surface and a lower surface; an agitation drive shaft mounted through an aperture in the lid having at least one stirrer affixed thereto; and a fluid conduit having a conduit inlet and a conduit outlet and being in fluid communication with a discharge opening.

In one embodiment, the fluid conduit is a dip tube located through a periphery area of the lid and outside of a path of the stirrer. In another embodiment, the fluid conduit can be defined by a hollow passage in or on the agitation drive shaft. A detailed embodiment provides that the conduit inlet comprises one or more fluid paths in the stirrer that are in fluid communication with the hollow passage in or on the agitation drive. The fluid path(s) may comprise any shape adapted to convey paint or toner from the body of the container into the hollow passage, and in one embodiment can comprise a screened opening at an intake end thereof to facilitate mixing and/or filtering of the paint or toner upon assembly and use of the cover assembly with the paint or toner container. In a detailed embodiment, the fluid path(s) comprise one or more veins. In one embodiment, the fluid path(s) are formed by a porous structure within the stirrer paddles.

Another embodiment provides that the cover assembly further comprises a fluid coupler that is in fluid communication with the conduit outlet and the discharge opening. When the fluid conduit is defined by a hollow passage in or on the agitation drive shaft, the agitation shaft drive can pass through the fluid coupler. The fluid coupler can comprise a coupler outlet and a compartment. The fluid coupler can be affixed to the lower surface of the lid.

One or more embodiments include an element that couples to the mixing rack upon assembly of the cover assembly with the paint or toner container. Specifically, the element can comprise a connector of the agitation drive shaft that can couple to the mixing rack upon assembly of the cover assembly with the paint or toner container located on the mixing rack.

In other embodiments, the cover assembly further comprises a discharge valve in fluid communication with the discharge opening. The discharge valve can comprise a body, a movable core, and a dispensing port such that in a first position, the movable core permits fluid communication between the discharge opening and the dispensing port and in a second position, the movable core closes the discharge opening.

Another embodiment provides that the lid further comprises an air inlet path. Another embodiment provides that the fluid conduit is in fluid communication with a pump.

Other embodiment can include one or more mounting clamps that affix the cover assembly to the paint or toner container upon assembly of the cover assembly with the paint or toner container.

In one or more embodiments, the stirrer comprises a semi-rigid frame. The stirrer can comprise a porous or foamed polymer. The semi-rigid frame can comprise one or more edges that are effective to contact the bottom or side of the paint or toner container upon assembly of the cover assembly with the paint or toner container. In a detailed embodiment, the edge is formed from a fluoropolymer.

In a detailed aspect, the cover assembly comprises: a lid having an upper surface and a lower surface; and a hollow agitation drive shaft mounted through an aperture in the lid, the hollow agitation drive comprising a conduit inlet and conduit outlet and defining a fluid conduit that is in fluid communication with a fluid coupler, and having a stirrer affixed thereto; the fluid coupler comprising a coupler outlet and a compartment that is in fluid communication with the fluid conduit and a discharge valve; wherein the hollow agitation drive shaft passes through the fluid coupler.

The agitation drive shaft can couple to the mixing rack with a connector upon assembly of the cover assembly with the paint or toner container located on the mixing rack. The lid can further comprise an air inlet path. The fluid conduit can be in fluid communication with a pump.

In specific embodiments, one or more of the following components are disposable: the lid, the hollow agitation drive shaft, and the fluid coupler.

The discharge valve can comprise a body, a movable core, and a dispensing port such that in a first position, the movable core permits fluid communication between the discharge opening and the dispensing port and in a second position, the movable core closes the discharge opening. A detailed embodiment provides that the valve is disposable.

Another aspect is a method for dispensing paint or toner from a container located on a mixing rack, the method comprising: assembling a cover assembly with the container; agitating the paint or toner in the container; and moving the paint or toner from the container through a fluid path to a discharge opening in the lid without the reliance on gravity. The cover assembly can be any embodiment disclosed herein.

In one embodiment, the method can comprise moving the paint or toner from the container comprises by applying air or other gas pressure through an air inlet path in the cover assembly. In another embodiment, the method can comprise moving the paint or toner from the container by pumping the paint or toner through the fluid path. The fluid path can comprise components that are disposable.

These and other aspects of the invention are described in the detailed description below. In no event should the above summary be construed as a limitation on the claimed subject matter.

### BRIEF DESCRIPTION OF THE DRAWINGS

The accompanying drawings are included to provide a further understanding of the invention described herein and are incorporated in and constitute a part of this specification. The drawings illustrate exemplary embodiments. Certain features may be better understood by reference to the following detailed description when considered in connection with the accompanying drawings, in which like reference numerals designate like parts throughout the figures thereof, and wherein:

FIG. 1 is a schematic drawing of a covered container assembly of one embodiment;

FIG. 2 is a cut-away drawing of the covered container assembly of one embodiment;

FIG. 3 is a cross-section view of a fluid coupler and fluid conduit of one embodiment; and

FIG. 4 is schematic drawing of an exemplary discharge valve.

The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

Before describing several exemplary embodiments of the invention, it is to be understood that the invention is not limited to the details of construction or process steps set forth in the following description. The invention is capable of other embodiments and of being practiced or being carried out in various ways.

Provided are cover assemblies for dispensing liquids such as paints or toners under agitation from containers or cans without reliance on gravity. That is, the covers do not interfere with the structure needed to agitate the paint or other liquid while at the same time eliminating problems associated with gravity-fed dispensers. Dispensing can be done, for example, pneumatically or by pumping from the cans. Covered containers utilizing such cover assemblies are also disclosed. Methods for dispensing paint or toner from a container located on a mixing rack comprise assembling a cover assembly with the container; agitating the paint or toner in the container; and moving the paint or toner from the container through a fluid path to a discharge opening in the lid without reliance on gravity.

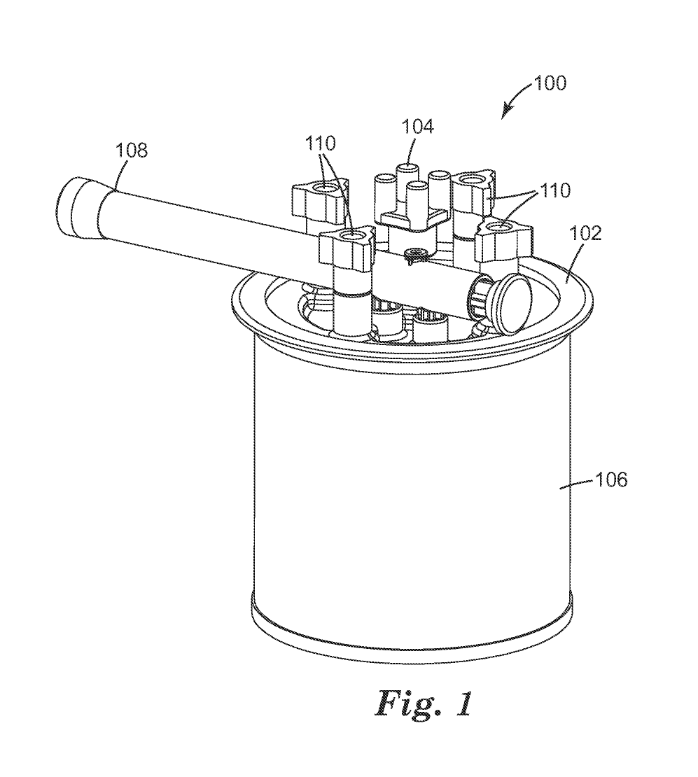

Turning to FIG. 1, a covered container assembly 100 comprises a container 106 for holding liquids such as paint or toner and a cover assembly 102. Exemplary paints are those that are solvent-based and are stored under agitation, although other paints and liquids that have varying requirements for agitation are also included within the scope of this disclosure. The cover assembly is optionally attached to a discharge valve 108. Any desired element of the covered container assembly can be used to secure or engage the assembly to a mixing rack. In a specific embodiment, a connector on the agitation drive, for example, an agitation drive coupler 104 is used. Exemplary structural devices for coupling with the rack include rubber wheels, gears, or prongs. Optionally, clamping structures 110 can be used to affix the cover assembly 102 to the container 106.

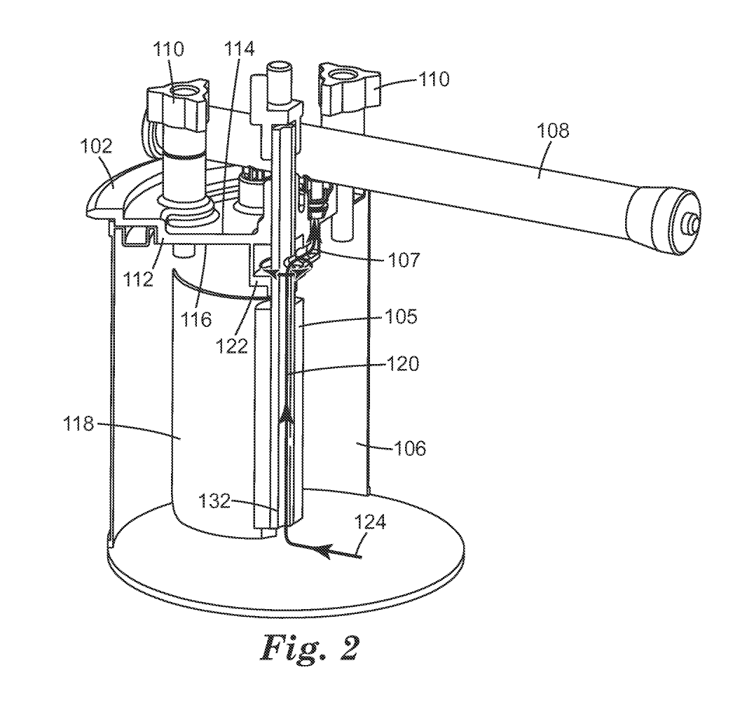

In FIG. 2, a cut-away drawing of the covered container assembly 100 of one embodiment is provided. The covered container assembly comprises the cover assembly 102 and the container 106. The cover assembly 102 comprises a lid 112 having a upper surface 114 and a lower surface 116; an agitation drive shaft 105 mounted through an aperture in the lid 112 having a least one stirrer 118 affixed thereto; and a fluid conduit 120 having an inlet 132 and being in fluid communication with a discharge opening 107.

One embodiment, not shown, is one where a dip tube is provided as the fluid conduit, such that the dip tube is positioned to extend from the lid while avoiding the path of the stirrer. In one particular example, such a dip tube is positioned along a periphery area of the lid and outside of a path of the stirrer. In one embodiment, the stirrer does not extend the entire way to the container wall to allow space for a dip tube.

It may be desirable to provide a stirrer that has a semi-rigid frame. In this way, stirrers, also referred to as paddles, can be curved or bent for insertion into the container, which in certain structures, contain a ridge towards the top of the container to facilitate assembly of a lid on the container. The surface area provided for mixing can, therefore, be larger as compared to the use of metal or non-flexible stirrers or paddles, which are sized smaller in order to clear the ridge of the container. The material for the stirrer can any material that is compatible with the paint or toner. It can be, for example, a porous or foamed polymer. To facilitate efficient use of liquid in the container, the semi-rigid frame can comprise one or more edges that are effective to contact the bottom and/or side of the paint or toner container upon assembly of the cover assembly with the paint or toner container. In this way, the fluid close to the walls and the bottom of the container can remain well-mixed while the formation of a skin layer on the container's inner surfaces is discouraged. An exemplary material for the edge comprises a fluoropolymer.

In a detailed embodiment where the stirrer 118 is designed to scrape or nearly touch the inside surface of the container 106, the fluid conduit 120 can be defined by a hollow passage in the agitation drive shaft 105. The conduit inlet can comprise an opening at a bottom end of the agitation drive shaft 132 or, not shown, one or more fluid paths, such as veins, in the stirrer that is in fluid communication with the hollow passage. In addition, the fluid path or vein can comprise one or more screened openings to facilitate mixing (e.g., through enhanced turbulence) and/or filtering of the paint or toner upon assembly and use of the cover assembly with the paint or toner container. Placement of the stirrers is generally such that the fluid paths in the stirrer are kept below a level of liquid in the container. The screened, or also referred to as meshed, opening can be formed out of materials compatible with the paint or toner and at desired gauges and configurations to provide effective mixing and/or filtering.

Also in this embodiment, the cover assembly further comprises a fluid coupler 122 in fluid communication with the fluid conduit 120 and the discharge opening 107. The agitation shaft drive 105 then passes through the fluid coupler 122. A fluid path 124 shows the path of paint or other fluid upon application of gas pressure or a pump to the fluid, where the fluid enters the fluid conduit 120 through the opening at bottom of agitation drive shaft 132, then flows into the fluid coupler 122 and out of the discharge opening 107 and into a discharge valve 108. An air inlet, not shown, can extend through the lid 112 to allow for venting of the container and/or inflow of air or other gas to provide pneumatic movement of the paint or other liquid inside the container. As desired, the paint or other liquid can be moved by the use of a pump that is in fluid communication with the fluid conduit 120. Disposable pumps may be desirable for this application. Examples of disposable pumps that may be useful in embodiments of the present disclosure are described in U.S. Pat. No. 7,674,100 B2 (Pankhurst, et al., “Pump with Conveyance Chamber Formed in Outer Rotor Surface”) and U.S. Pub. No. 2012/0034122 A1 (Pankhurst, et al., “Pump with Resilient Seal”), the disclosures of which are hereby incorporated by reference in their entirety.

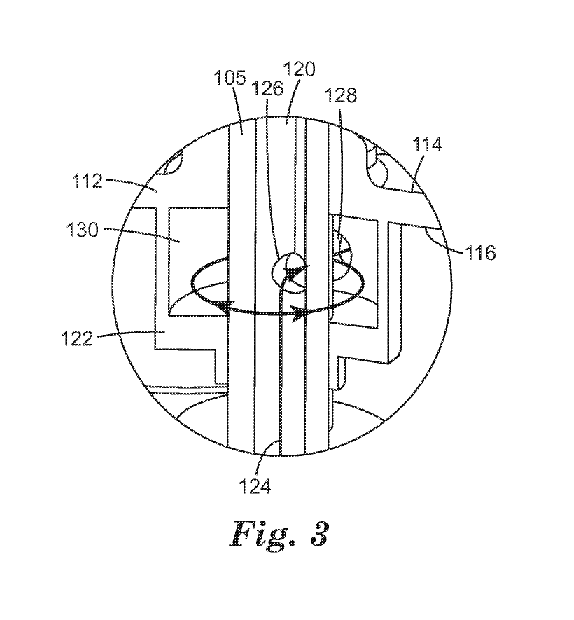

FIG. 3 shows a cross-section view of a fluid coupler and fluid conduit of one embodiment, where the agitation drive shaft 105 comprises a conduit outlet 126 and the fluid coupler 122 comprises a compartment 130 and a coupler outlet 128 that leads to the discharge opening (107 of FIG. 2) and/or discharge valve (not shown). The fluid path 124 shows that fluid in the fluid conduit 120 flows out of the conduit outlet 126 which is part of the agitation drive shaft 105 and rotates when the shaft rotates, and enters the compartment 130, exiting the compartment 130 through the coupler outlet 128. In this embodiment, the fluid coupler 122 is annular and surrounds the agitation drive shaft 105, allowing for the geometry and movement of the agitation drive shaft 105. That is, the agitation drive shaft 105 and conduit outlet can rotate and the fluid coupler 122 is stationary. The fluid coupler 122 can be affixed to the lower surface 116 of the lid. Methods of affixing the fluid coupler are known in the art, with exemplary methods comprising mechanically affixing using a screw or other fastener or sonically welding. The fluid coupler is fluidly isolated from all other parts of the container or assembly except for the fluid conduit 120 via, in this embodiment, the coupler inlet 126.

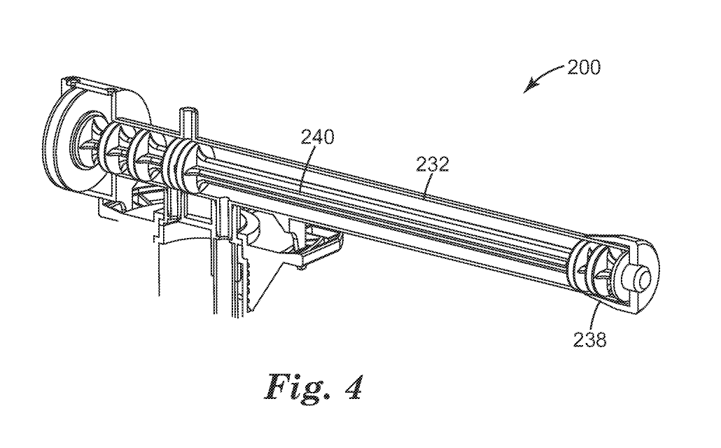

FIG. 4 is schematic drawing of an exemplary discharge valve 200, where a body 232 contains a movable core 240 and a dispensing port 238. The movable core, in a first position, permits fluid communication between the discharge opening and the dispensing port, and in a second position, the movable core closes the discharge opening. The core can be operated manually, pneumatically, or mechanically as desired. One or more suitable discharge valves are disclosed in co-assigned U.S. Patent Appln. Pub. No. 2010/0254730 directed to a pump-less toner dispensing cap and U.S. Ser. No. 61/611,662 directed to fluid dispensing apparatus, components, and methods, the disclosures of which are hereby incorporated by reference in their entirety.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

1-20. (canceled)

21. A cover assembly for use with a paint or toner container located on a mixing rack, the cover assembly comprising:
a lid having an upper surface and a lower surface; and
a hollow agitation drive shaft mounted through an aperture in the lid, the hollow agitation drive comprising a conduit inlet and a conduit outlet and defining a fluid conduit that is in fluid communication with a fluid coupler, and having a stirrer affixed thereto;
the fluid coupler comprising a coupler outlet and a compartment that is in fluid communication with the conduit outlet and a discharge valve;
wherein the hollow agitation drive shaft passes through the fluid coupler.

22. The cover assembly of claim 21, wherein the agitation drive shaft couples to the mixing rack with a connector upon assembly of the cover assembly with the paint or toner container located on the mixing rack.

23. The cover assembly of claim 21, wherein the lid further comprises an air inlet path.

24. The cover assembly of claim 21, wherein the fluid conduit is in fluid communication with a pump.

25. The cover assembly of claim 21, wherein one or more of the following components are disposable: the lid, the hollow agitation drive shaft, and the fluid coupler.

26. The cover assembly of claim 21 wherein the discharge valve comprises a body, a movable core, and a dispensing port such that in a first position, the movable core permits fluid communication between the discharge opening and the dispensing port and in a second position, the movable core closes the discharge opening.

27. The cover assembly of claim 26, wherein the valve is disposable.

28. A method for dispensing paint or toner from a container located on a mixing rack, the method comprising:
assembling a cover assembly with the container;
agitating the paint or toner in the container; and
moving the paint or toner from the container through a fluid path to a discharge opening in the lid without reliance on gravity.

29. The method of claim 28, wherein the cover assembly comprises:
a lid having an upper surface and a lower surface;
an agitation drive shaft mounted through an aperture in the lid having at least one stirrer affixed thereto; and
a fluid conduit having a conduit inlet and a conduit outlet and being in fluid communication with a discharge opening through the lid.

30. The method of claim 28 comprising moving the paint or toner from the container comprises by applying air or other gas pressure through an air inlet path in the cover assembly.

31. The method of claim 28 comprising moving the paint or toner from the container by pumping the paint or toner through the fluid path.

32. The method of claim 28, wherein the fluid path comprises components that are disposable.

33. The method of claim 28, wherein the cover assembly comprises:
a lid having an upper surface and a lower surface; and
a hollow agitation drive shaft mounted through an aperture in the lid, the hollow agitation drive comprising a conduit inlet and a conduit outlet and defining a fluid conduit that is in fluid communication with a fluid coupler, and having a stirrer affixed thereto;
the fluid coupler comprising a coupler outlet and a compartment that is in fluid communication with the conduit outlet and a discharge valve;
wherein the hollow agitation drive shaft passes through the fluid coupler.
